(19) United States
(12) Patent Application Publication
(10) Pub. No.: US 2024/0009971 A1
(43) Pub. Date: Jan. 11, 2024

(54) Windows With Selective Area Adjustable Haze

(71) Applicant: Apple Inc., Cupertino, CA (US)

(72) Inventors: David E. Kingman, San Francisco, CA (US); Albert J. Golko, Saratoga, CA (US); Peter F. Masschelein, Campbell, CA (US)

(21) Appl. No.: 18/472,449

(22) Filed: Sep. 22, 2023

Related U.S. Application Data
(63) Continuation of application No. PCT/US2022/023527, filed on Apr. 5, 2022.
(60) Provisional application No. 63/172,459, filed on Apr. 8, 2021.

(51) Int. Cl. B32B 17/10; F21V 8/00; B60J 3/04

(52) U.S. Cl. CPC B32B 17/10504; B32B 17/10036; B32B 17/10541; B32B 17/1055; B32B 17/10211; G02B 6/0095; G02B 6/005; B60J 3/04; B32B 2605/08

(57) ABSTRACT

A light guide may be embedded in a window. The light guide may have cladding and a light guide core layer embedded in the cladding. The light guide core layer may include a polymer layer configured to receive light from a light source. A selective area adjustable haze layer in the light guide core layer may have segmented transparent electrodes that can be controlled to cause one or more selected areas of the adjustable haze layer to become hazy. Light from the light source may be guided across the window within the light guide core layer in accordance with the principal of total internal reflection. When a dynamically adjusted hazy portion of the selective area adjustable haze layer is reached by the guided light, the guided light will be scattered out of the light guide.

This application is a continuation of international patent application No. PCT/US2022/023527, filed Apr. 5, 2022, which claims priority to U.S. provisional patent application No. 63/172,459, filed Apr. 8, 2021, which are hereby incorporated by reference herein in their entireties.

### FIELD

This relates generally to structures that pass light, and, more particularly, to windows.

### BACKGROUND

Windows are used in buildings and vehicles. Windows may be formed from glass or other transparent material.

### SUMMARY

A window in a system such as a building or vehicle may have inner and outer window layers. A light guide may be formed between the inner and outer window layers. The light guide may have cladding and a light guide core layer embedded in the cladding. The light guide core layer may include a polymer layer configured to receive light from a light source.

A selective area adjustable haze layer may be included in the light guide core layer. The selective area adjustable haze layer may have segmented transparent electrodes that can be individually controlled. This allows one or more desired areas of the adjustable haze layer to be selectively placed in a hazy state.

Light from the light source may be guided across the window within the light guide core layer in accordance with the principal of total internal reflection. When a dynamically adjusted hazy portion of the selective area adjustable haze layer is reached by the guided light, the guided light will be scattered out of the light guide. Scattered light may produce visible shapes on the interior and/or exterior of the window and may serve as interior and/or exterior illumination for the system. Any suitable shapes may be used for the areas of adjustable haze. For example, adjustable haze shapes may be rectangular, may have elongated strip shapes, may have the shape of an indicator or icon, or other suitable shapes.

### BRIEF DESCRIPTION OF THE DRAWINGS

FIG. 1 is a cross-sectional view of an illustrative system with a window in accordance with an embodiment.

FIG. 2 is a cross-sectional side view of an illustrative adjustable haze layer in accordance with an embodiment.

FIG. 3 is a cross-sectional side view of an illustrative window in accordance with an embodiment.

FIG. 4 is a top view of an illustrative window in accordance with an embodiment.

FIG. 5 is a cross-sectional side view of an illustrative window that includes an adjustable mirror layer in accordance with an embodiment.

FIG. 6 is a side view of an illustrative window with horizontally extending adjustable-haze strips in accordance with an embodiment.

### DETAILED DESCRIPTION

Systems may be provided with windows. Windows may be formed by laminating multiple transparent layers together. For example, a window may be formed from two or more glass layers laminated together with adhesive.

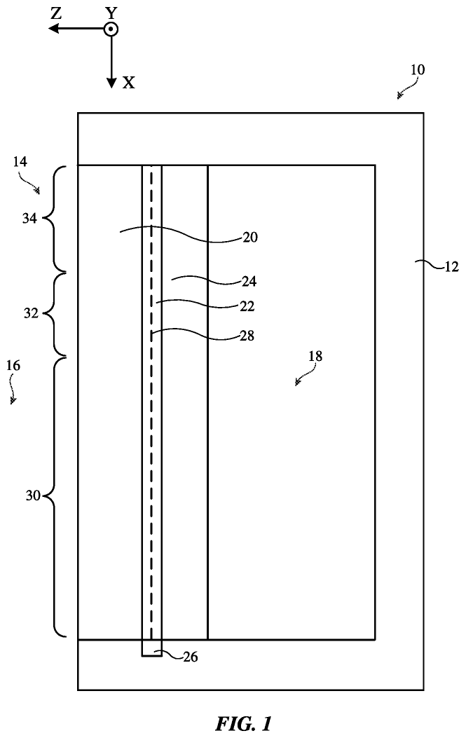

An illustrative system of the type that may include windows is shown in FIG. 1. System 10 may be a vehicle, building, or other type of system. Illustrative configurations in which windows are provided in a vehicle such as an automobile may sometimes be described herein as an example. This is merely illustrative. Windows may be formed in any suitable systems.

As shown in FIG. 1, system 10 may have support structures such as body 12 for supporting one or more windows. Body 12 may be a vehicle body that includes doors, trunk structures, a hood, side body panels, a roof, and/or other body structures. Body 12 may be configured to surround and enclose interior region (interior) 18. System 10 may include a chassis to which wheels are mounted, may include propulsion and steering systems, and may include other vehicle systems. Seats may be formed in interior region 18 of body 12. Window 14, which may be a vehicle window, and portions of body 12 may be used to separate interior region 18 of system 10 from the exterior environment (exterior region 16) that is surrounding system 10.

Windows such as window 14 may be coupled to body 12 and may be configured to cover openings in body 12. Motorized window positioners coupled to body 12 may be used to open and close windows 14, if desired. The windows in system 10 such as window 14 may include a front window mounted within an opening in body 12 at the front of a vehicle, a moon roof (sun roof) window or other window extending over some or all of the top of a vehicle, a rear window at the rear of a vehicle, and/or side windows on the sides of a vehicle. Window 14 may be flat (e.g., window 14 may lie in the X-Y plane of FIG. 1) or window 14 may have one or more curved portions (e.g., window 14 may have a curved cross-sectional profile and may be oriented to lie generally parallel to the X-Y plane so that a convex surface of window 14 faces outwardly in direction Z of FIG. 1). The area of each window 14 in system 10 may be at least 0.1 m², at least 0.5 m², at least 1 m², at least 5 m², at least 10 m², less than 20 m², less than 10 m², less than 5 m², or less than 1.5 m² (as examples).

System 10 may include control circuitry and input-output devices. Control circuitry in system 10 may include one or more processors (e.g., microprocessors, microcontrollers, application-specific integrated circuits, etc.) and storage (e.g., volatile and/or non-volatile memory). Input-output devices in system 10 may include displays, sensors, buttons, light-emitting diodes and other light-emitting devices, haptic devices, speakers, and/or other devices for providing output and/or for gathering environmental measurements and/or user input. The sensors may include ambient light sensors, touch sensors, force sensors, proximity sensors, optical sensors, capacitive sensors, resistive sensors, ultrasonic sensors, microphones, three-dimensional and/or two-dimensional images sensors, radio-frequency sensors, and/or other sensors. Output devices may be used to provide a user with haptic output, audio output, visual output (e.g., displayed content, light, etc.), and/or other suitable output. During operation, control circuitry in system 10 may gather user input (e.g., touch input from a touch sensor embedded in a window or other portion of system 10), environmental information, and other information from sensors and/or other input-output devices and may control adjustable components in system 10 based on this gathered information.

Window 14 may be formed from one or more layers of transparent glass, clear polymer (e.g., polycarbonate, acrylic, etc.), polymer adhesive, and/or other layers. For example, window 14 may be formed from two glass layers or three glass layers laminated together with adhesive. The glass layers may be chemically or thermally tempered (e.g., to create compressive stress on the surfaces of the glass layers that helps strengthen the glass layers). In the illustrative configuration of FIG. 1, window 14 is formed from outer window layer 20 and inner window layer 24 (e.g., outer and inner structural glass layers and/or other layers of transparent material). The thicknesses of layers 20 and 24 may be, for example, 0.5 mm to 3 mm, at least 0.3 mm, at least 0.5 mm, less than 4 mm, less than 3 mm, or other suitable thickness. Outer layer 20 and inner layer 24 may be laminated together using a polymer layer such as interposed adhesive layer 22 (e.g., an adhesive layer with one surface bonded to the inwardly facing surface of outer window layer 20 and an opposing surface bonded to the outwardly facing surface of inner window layer 24). Adhesive layer 22 may have a refractive index that is matched (e.g., within within 0.07, within 0.05, or within 0.03) to that of layers 20 and 24 or may have a lower or higher refractive index than layers 20 and 24 (e.g., lower or higher by at least 0.1, at least 0.15, at least 0.2, etc.). Examples of polymers that may be used for forming adhesive layer 22 include thermoplastic polyurethane, ethylene-vinyl acetate, and polyvinyl butyral. Layer 22 may, if desired, include polymer configured to provide sound dampening (e.g., a soft polyvinyl butyral sublayer or other acoustic film embedded within layer 22).

Outer window layer 20 may be formed from a single layer of structural window glass or may include multiple sublayers such as one or more layers of glass, optically clear adhesive, and/or polymer films. Inner window layer 24 may similarly be formed from a single layer of structural window glass or may include multiple sublayers such as one or more layers of glass, optically clear adhesive, and/or polymer films. In the present example, layers 20 and 24 are glass layers formed from glass that has one or more areas with planar surfaces and/or one or more areas with curved cross-sectional profiles (e.g., portions where the outwardly facing surface of window 14 is convex).

If desired, optional fixed and/or adjustable optical components may be incorporated into window 14. As shown in FIG. 1, for example, one or more optical components such as optical layer 28 may be incorporated into window 14 (e.g., one or more layers such as layer 28 may be embedded in adhesive layer 22). Each layer 28 may be a fixed and/or adjustable optical layer providing fixed and/or adjustable amounts of opacity, polarization, reflection, color cast, haze, and/or other optical properties. Each of layers 28 may be formed from a single layer that is uniform across most or all of window 14 or may be formed from a segmented layer that has different areas that provide different fixed and/or adjustable properties. As an example, a fixed layer may have a first half that covers a first half area of window 14 and may have a non-second half that covers a non-overlapping second half area of window 14 and the first and second halves may be characterized by different fixed amounts of opacity, polarization, reflection, color cast, haze, and/or other optical properties. As another example, an electrically adjustable layer may have a first half that covers a first half area of window 14 and may have a second half area that covers a second half area of window 14 and the first and second halves may be independently electrically adjusted to provide the first and second half areas with desired respective amounts of opacity, polarization, reflection, color cast, haze, and/or other optical properties. Configurations in which windows 14 have more than two areas with different fixed and/or adjustable components may also be used (e.g., window 14 may have N different areas with fixed and/or adjustable optical properties, where the value of N is at least 3, at least 5, at least 10, at least 15, less than 50, less than 25, less than 20, or less than 10, as examples).

In some arrangements, layer 28 may include a light guide formed from a transparent layer of material (e.g., a transparent light guide core). For example, layer 28 may have a light guide that receives light from light source 26. Light source may include one or more light-emitting devices such as light-emitting didoes and/or laser diodes (e.g., multiple light-emitting devices arranged along one or more edges of window 14). Light source 26 may provide visible light that is guided across window 14 within the light guide by total internal reflection.

Light-scattering structures may be provided in one or more areas of window 14 to extract some of the guided light from the light guide (e.g., inwardly to produce illumination for interior region 18 and/or outwardly). The light-scattering structures may be provided by one or more layers of material with fixed and/or adjustable haze. In an illustrative configuration, one or more portion of window 14 are overlapped by an adjustable haze layer (e.g., layer 28 may be an adjustable haze layer).

The adjustable haze layer may have different areas that can be adjusted independently. For example, an adjustable haze layer may have a first area 30, a second area 32, and a third area 34, that can each be adjusted independently to provide a corresponding desired amount of haze and associated light scattering. If, as an example, areas 30 and 34 are adjusted to exhibit no haze while area 32 is adjusted to produce haze, light from light source 26 that is propagating within the light guide of layer 28 will be scatted outwardly and/or inwardly from layer 28 in area 32 but not in areas 30 and 34.

In some arrangements, light source 26 may be omitted (e.g., so that haze may be adjusted in window 14 without scattering light out of a light guide in window 14). Arrangements for window 14 that include a one or more regions with fixed light-scattering structures may also be used, if desired. In an illustrative configuration, which is sometimes described herein as an example, layer 28 includes a light guide that receives light from light source 26 and window 14 has a segmented adjustable haze layer that can be adjusted to scatter light out of the light guide at desired areas.

The windows in system 10 may be completely planar (e.g., the inner and outer surfaces of window 14 may be flat) and/or some or all of the windows in system 10 may have surface curvature. The inner and outer surfaces of each window may as an example, have compound curvature (e.g., non-developable surfaces characterized by curved cross-sectional profiles taken along the X and Y directions of FIG. 1) and/or may have developable surfaces (surfaces with zero Gaussian curvature that can be flattened without distortion). Curved window shapes may be produced by heating glass until the glass is sufficiently soft to form into a desired shape (e.g., under the force of gravity and/or using molds). Illustrative arrangements in which window 14 is planar may sometimes be described herein as an example. In general, however, windows 14 may include one or more planar areas and/or one or more areas with curved cross-sectional profiles.

Any suitable adjustable optical component layer may be used in providing layer 28 with adjustable haze. Examples of adjustable haze layers that may be used include adjustable liquid crystal haze layers such as polymer dispersed liquid crystal layers (polymer layers with dispersed droplets of liquid crystal material) and polymer network liquid crystal layers (liquid crystal material stabilized by a polymer network).

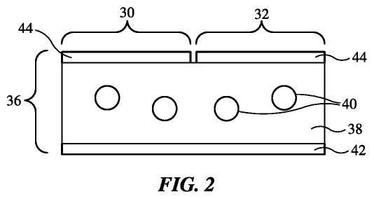

Consider, as an example, adjustable haze layer 36 of FIG. 2 (e.g., a polymer dispersed liquid crystal layer). As shown in the cross-sectional side view of FIG. 2, adjustable haze layer 36 may include a layer of polymer such as polymer layer 38 containing embedded droplets 40 of liquid crystal material. Electrodes 42 and 44 may be formed on opposing surfaces of layer 38. Electrodes 42 and 44 may be formed from transparent conductive material (e.g., metal that is sufficiently thin to be transparent to visible light, indium tin oxide or other transparent conductive material, etc.). When a voltage is applied across the layer 38 using the electrodes on the opposing surfaces of layer 38, an electric field is applied to the liquid crystal material in droplets 40. This orients the liquid crystals in droplets 40 and changes the refractive index of droplets 40 for light passing through window 14. In a first state, a first voltage is applied across the opposing electrodes and the refractive index of droplets 40 matches that of the polymer material in layer 38. In this first state, layer 36 is placed in a low haze mode of operation (e.g., there is no refractive index difference between droplets 40 and layer 38, so light is not scattered and layer 36 is not hazy). In a second state, a second voltage is applied across the opposing electrodes and the refractive index of droplets 40 does not match that of layer 38. In this state, droplets 40 serve as light-scattering structures and layer 36 becomes hazy. If desired, layer 36 can also be operated at intermediate voltage levels, in which a corresponding intermediate amount of haze is produced.

Electrodes 42 and 44 may cover all of the surface of window 14 or may cover only part of window 14. Electrodes 42 and/or 44 may be formed from continuous uninterrupted electrode layers or may be segmented. As shown in FIG. 2, for example, an electrode such as electrode 42 may be unsegmented and another electrode such as electrode 44 may be segmented (e.g., to form left and right electrode segments in this example). This segmented arrangement allows the left and right portions of layer 36 to be adjusted separately and to correspondingly exhibit different amounts of haze.

Adjustable haze components such as adjustable haze layer may be attached to inner or outer surfaces of window 14 and/or may be embedded between structural window layers. As an example, layers 20 and 24 may be structural glass layers (e.g., an outer glass window layer and an inner glass window layer) and a layer of polymer such as polymer adhesive 22 may be used to laminated layers 20 and 24 together to form window 14. In this type of arrangement, an adjustable haze layer such as adjustable haze layer 36 may be embedded within window 14 between layers 20 and 24 (e.g., in adhesive layer 22 and/or elsewhere between the inwardly facing surface of outer layer 20 and the opposing outwardly facing surface of inner layer 24). A light guide structure such as a transparent polymer film may, if desired, be placed adjacent to the adjustable haze layer to help guide light.

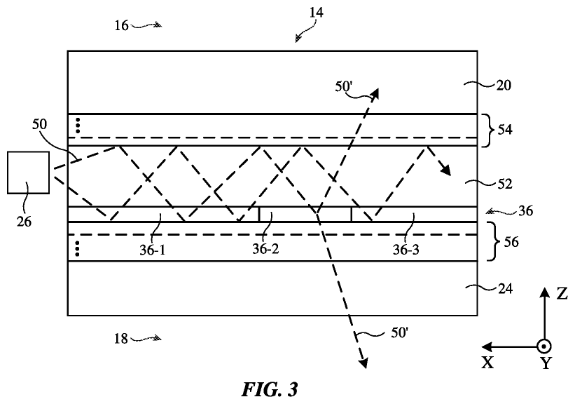

Consider, as an example, window 14 of FIG. 3. As shown in the cross-sectional view of window 14 of FIG. 3, window 14 may include outer window layer 20 and inner window layer 24. Light guide layer 52 may be formed from a transparent polymer layer (e.g., a polymer film). Adjustable haze layer 36 may be located adjacent to layer 52 (e.g., above or below layer 52) and may be attached to layer 52 using an intervening layer of adhesive and/or using heat and/or pressure to laminated layers 52 and 36 together. Layers 54 and 56 may be used to attach layers 20 and 24 to the other layers of window 14. Layers 54 and 56 may be formed from polymer (e.g., adhesive 22) and/or may include one or more different materials. For example, each of layers 54 and 56 may include one or more sublayers of material such as thermoplastic polyurethane, ethylene-vinyl acetate, polyvinyl butyral, optically clear adhesive, one or more polymer films, etc.

Layer 36 may be a selective area adjustable haze layer (sometimes referred to as a segmented adjustable haze layer and/or a patterned adjustable haze layer, etc.). In the example of FIG. 3, adjustable haze layer 36 has three individually adjustable non-overlapping areas such as area 36-1, 36-2, and 36-3 (each with a separate electrode). In general, layer 36 may have any suitable number of areas (e.g., at least two, at least five, at least ten, at least 25, at least 50, fewer than 250, fewer than 100, fewer than 40, fewer than 30, etc. and each of these areas may have a size of at least 1 cm², at least 10 cm², at least 100 cm², at least 1000 cm², less than 100,000 cm², less than 10,000 cm², less than 5000 cm², or less than 500 cm², as examples.

Layer 52 and layer 36 may have similar or identical refractive index values. For example, the refractive index of layer 52 and layer 36 may differ by less than 0.05 (as an example). Layer 54 may be used to attach layer 20 to layer 52 and layer 56 may be used to attach layer 24 to layer 36.

In a first illustrative light guiding arrangement, window 14 forms a light guide (e.g., all of the layers of window 14 collectively serve as a light guide core) and cladding for the light guide core is provided by the air on the inner and outer surfaces of window 14. With this type of arrangement, light 50 is guided by total internal reflection within window 14 and tends to be guided between the outwardly facing surface of outer window layer 20 and the opposing inwardly facing surface of inner window layer 24. To minimize light reflections at the interfaces between the different layers of material in window 14 in this type of arrangement, the refractive index difference at each layer-to-layer interface may be less than 0.2, less than 0.1, less than or other suitable value. For example, layers 54 and 56 may be formed from adhesive 22 and may be index matched (e.g., within 0.1, within 0.05, etc.) to the index of layer 52 and/or the index of layers 20 and 24 to help reduce reflections at the interfaces between layers 52 and layers 54 and 56 and to help reduce reflections at the interface between layers 20 and 54 and at the interface between layer 24 and layer 56. When it is desired to scatter light inwardly and/or outwardly from window 14, a given area of layer 36 may be switched from its unhazy (clear) state to a hazy state. When light 50 that is being guided across window 14 reaches the hazy area of layer 36, this light will be scattered out of window 14 (e.g., to serve as interior illumination for system 10 and/or to serve as outwardly directed illumination). The hazy area will generally appear as a bright illuminated area whereas non-hazy window regions will appear clear. If desired, selective privacy may be provided in a particular area using layer 36 (e.g., by activating the haze of the given area, even in scenarios in which light 50 is not present).

In a second illustrative light guiding arrangement, which is illustrated in FIG. 3, light guide layer 52 and adjustable haze layer 36 serve together as a light guide core layer for a light guide. In this configuration, layer 52 and layer 36 may have matched refractive index values (e.g., within 0.1, within 0.5, etc.) and the refractive index values of layers 54 and 56 are lower than the refractive index of the core (e.g., by at least 0.07, at least 0.1, at least 0.15, or at least as examples). The relatively lower refractive index values of layers 54 and 56 allows layers 54 and 56 to serve as cladding (cladding layers) for the light guide.

During operation, light 50 will be guided across window 14 within the light guide core layer unless scattered outwardly by light-scattering structures in layer 36. Total internal reflection within the core layer is ensured by selecting refractive index values for the cladding (e.g., layers 54 and 56 which may be formed from adhesive 22 and/or which may include other layer(s) of polymer and/or other transparent material) that are lower than the refractive index of the core layer (e.g., by at least 0.07, at least 0.1, at least 0.15, at least 0.2, etc.). In this second illustrative arrangement, the cladding may, as an example, have a refractive index value that is matched to that of layers 20 and 24, may have a refractive index that is lower than layers 20 and 24, or may have a refractive index value that is higher than layers 20 and 24.

As shown in FIG. 3, light 50 that is emitted into the edge of the light guide core by light source 26 is guided across window 14 (e.g., in the X-Y plane) by total internal reflection within the light guide core layer (core) made up of layer 52 and layer 36, provided that layer 36 is in its transparent (non-hazy) state.

A user may, if desired, adjust layer 36. For example, control circuitry in device 10 may use a touch sensor, microphone, or other input device to receive user input. The user input may specify that a middle portion of window 14 such as the portion of window 14 corresponding to area 36-2 of FIG. 3, should be selectively placed in its hazy state. In response, the control circuitry may adjust the voltages across the electrodes of adjustable haze layer 36 in areas 36-1 and 36-3 to place layer 36 in a clear (non-hazy) state in areas 36-1 and 36-3 while adjusting the voltage across the electrodes of adjustable haze layer 36 in area 36-2 to place layer 36 in a hazy state in area 36-2. Light 50 that is traveling through the light guide core layer formed from layer 52 and layer 36 will generally be confined within this layer by total internal reflection. In area 36-2, however, a portion of light 50 will interact with the light-scattering structures that are formed in area 36-2 and will therefore be scattered out of the waveguide (outwardly and/or inwardly), as shown by scattered light rays 50′ (e.g., total internal reflection will be locally defeated within area 36-2). Inwardly scattered light may serve as interior illumination for interior region 18 of system 10. Outwardly scattered light may reach objects and viewers in exterior (exterior) region 16. Viewers in exterior region 16 who are viewing window 14 from the outside and/or occupants of system 10 in interior region 18 who are viewing window 14 from interior region 18 will observe a diffuse illuminated area on the outer (or inner) surface of window 14 that has a shape matching the outline of area 36-2. If desired, layer 36 (and/or ancillary optical films adjacent to layer 36) may be used to help direct scattered light in a particular direction (e.g., outwardly or inwardly). Layer 36 may also be configured to scatter light equally in the outward and inward directions.

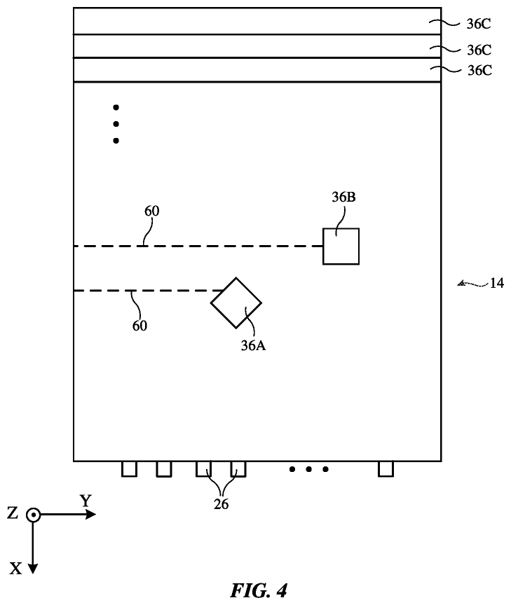

Selective area adjustable haze layer 36 may have individually adjustable areas (segments) of any suitable shape and/or size. Consider, as an example, window 14 of FIG. 4. As shown in FIG. 4, layer 36 may have electrodes that are divided into areas such as area 36A (e.g., a star-shaped area), area 36B (e.g., a rectangular patch), and areas 36C (e.g., a series of parallel stripes). If desired, thin conductive lines such as lines 60 (e.g., lines that are sufficiently narrow to reduce or eliminate visibility to the naked eye and/or lines formed from transparent conductive material) may be used to distribute control signals to the individually adjustable electrode areas of layer 36 from terminals coupled to the edge of the window. The individually adjustable electrode areas may include areas that are isolated from other adjustable electrode areas (e.g., electrode islands that are surrounded by non-adjustable portions of layer 36 and/or that are surrounded by portions of window 14 from which layer 36 is absent) and/or the individually adjustable electrode areas may include portions where numerous electrodes are placed adjacent to each other in a one-dimensional or two-dimensional array. When pixelating the electrodes of layer 36 in this way, individual electrodes may form respective parts of alphanumeric characters, respective parts of a status indicator, and/or other portions of other visual items (e.g., a multi-part visual indicator that forms an icon, etc.). Individual electrode shapes may also, if desired, be configured to present information by themselves. For example, a single segment of layer 36 or multiple related segments of layer 36 that are controlled together may be shaped to form a logo, an icon, a word, or other visual indicator.

Icons and other visual indicators may present information of interest to occupants of system 10 and/or to people in the vicinity of system 10. As an example, a warning icon may be presented when a vehicle is in motion and may be removed when the vehicle is not in motion, an alert icon such as a door open status indicator may be presented when doors of a vehicle are open and may be removed when the doors are all closed, etc.

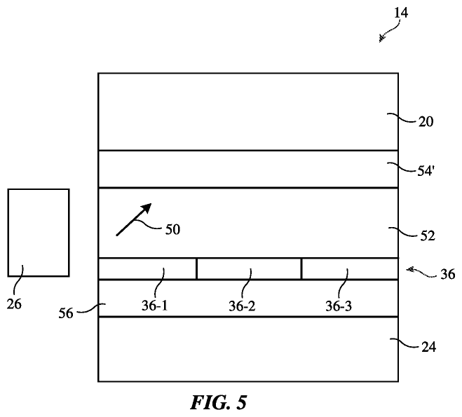

If desired, one or more additional adjustable optical component layers may be embedded between outer layer 20 and inner layer 24. Consider, as an example, the arrangement of window 14 of FIG. 5. In the example of FIG. 5, light guide layer 52 and adjustable haze layer 36 form a light guide core layer for a light guide. During operation, the light guide core layer receives light 50 from light source 26. Layer 56 forms an inner cladding layer for the light guide. Cholesteric liquid crystal layer 54′ may be incorporated into window 14 between layer 20 and layer 52 in place of layer 54 of FIG. 3. Layer 54′ of FIG. 5 may be formed from a layer of liquid crystal material sandwiched between a pair of opposing electrodes. The control circuitry of system 10 can control the alignment of the liquid crystals in the liquid crystal layer by adjusting the voltage applied across the layer using the electrodes. By adjusting the voltage, the reflectivity of layer 54′ may be adjusted (e.g., from a transparent state in which layer 54 is clear and does not absorb significant amounts of light passing through window 14 to a mirror-like reflective state). In the reflective state, light from exterior 16 is reflected back towards exterior 16 (e.g., window 14 will have a mirror-like appearance from the exterior of system 10). At the same time, the reflectivity of layer 54′ in this state will help confine light 50 within layer 52 (e.g., by preventing light 50 from escaping outwardly through layer 54′).

When areas 36-1, 36-2, and 36-3 of layer 36 are clear (e.g., in their non-hazy state), light 50 will be guided across window 14 within the light guide in accordance with the principal of total internal reflection. When it is desired to locally defeat total internal reflection, layer 36 can be adjusted to exhibit haze in one or more of its adjustable areas. For example, area 36-2 may be placed in a hazy state. This will scatter light from the light guide to provide internal illumination for interior 18. Occupants of system 10 in interior 18 will also be able to observe an illuminated shape corresponding to the hazy area. Layer 54′ may remain in the mirror state (e.g., to provide privacy for occupants of system 10 and to block outwardly directed scattered light) or some or all of layer 54′ may be placed in a clear state. For example, layer 54′ may have segmented individually adjustable electrodes so that a given portion of layer 54′ (e.g., an icon-shaped area overlapping area 36-2) may be selectively placed in a clear state to allow some of the light that is being scattered outwardly by the light-scattering particles of layer 36 in area 36-2 to pass outwardly through this given portion of layer 54′ for viewing by people in exterior region 16.

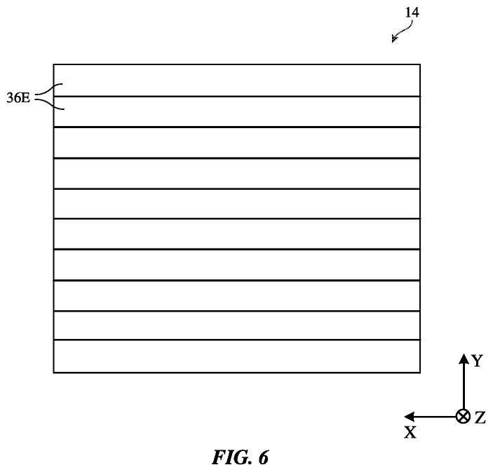

If desired, the segmented areas of layer 36 may be configured to cover window 14 (e.g., in a one-dimensional or two-dimensional array of closely spaced non-overlapping patches). The patches may be square, hexagonal, elongated strips, and/or patches of other shapes. Consider, as an example the one-dimensional array configuration of window 14 in FIG. 6. In the example of FIG. 6, window 14 is being viewed from the interior of system 10. Layer 36 in window 14 has elongated horizontally extending parallel strip-shaped electrodes 36E, each of which has a corresponding longitudinal axis running parallel to the horizontal (X) axis. Electrodes 36E are stacked on top of each other so that all of window 14 is covered (in this example). Each of electrodes 36E can receive a separate individually adjusted control signal from the control circuitry. This allows the haze of window 14 to be adjusted in strips. During operation, an occupant of system 10 who wishes to adjust window 14 may supply user input to a touch sensor strip in window 14 and/or may supply user input to a microphone or other input device. In response, the control circuitry of system 10 may issue corresponding control signals to each of electrodes 36E that place corresponding portions of layer 36 in a desired haze state.

If, as an example, a user desires privacy, all of the electrodes in layer 36 can be adjusted so that all of window 14 is hazy. This will help obscure an external viewers view of occupants in interior 18. Light source 26 can also be used to provide light 50 to the light guide in window 14 so that all of window 14 will emit diffuse light (e.g., diffuse interior illumination). If desired, light source 26 can be turned off.

When the user does not desire privacy, all of the electrodes in window 14 can be adjusted so that all of window 14 is entirely clear.

A user who desires partial privacy and/or partial illumination may adjust layer 36 so that a first region of layer 36 that is overlapped by a first set of respective electrodes 36E will be hazy (e.g., the area covered by the lower M of electrodes 36E) and so that a remaining second region of layer 36 that is overlapped by a second set of respective electrodes 36E will be clear and exhibit lower haze (e.g., the area above the lower M electrodes 36E that is covered by the remaining electrodes 36E). The number M may be adjusted dynamically by the user, effectively allowing the user to raise and lower a hazy electronically adjusted window panel in a vehicle or other system. The hazy portion of the panel may be unilluminated or may be illuminated using light from source 26.

In accordance with an embodiment, a system is provided that includes a support structure; a light source that emits light; and a window in the support structure, the window includes a light guide that guides the light by total internal reflection across the window and that has a selective area adjustable haze layer.

In accordance with another embodiment, the support structure includes a vehicle body; the selective area adjustable haze layer includes an adjustable layer selected from the group consisting of: a polymer dispersed liquid crystal layer and a polymer network liquid crystal layer; the window has an outer glass layer and an inner glass layer; and the light guide includes a polymer layer adjacent to the selective area adjustable haze layer.

In accordance with another embodiment, the window includes an outer glass layer and an inner glass layer.

In accordance with another embodiment, the light guide includes a transparent polymer layer and the transparent polymer layer and the selective area adjustable haze layer form a light guide core layer for the light guide.

In accordance with another embodiment, the light guide includes cladding.

In accordance with another embodiment, the cladding includes a polymer selected from the group consisting of: thermoplastic polyurethane, ethylene-vinyl acetate, and polyvinyl butyral.

In accordance with another embodiment, the system includes an electrically adjustable cholesteric liquid crystal layer adjacent to the light guide core layer.

In accordance with another embodiment, the selective area adjustable haze layer includes multiple individually adjustable electrodes in different respective areas of the window.

In accordance with another embodiment, the electrodes include multiple parallel elongated strip-shaped electrodes.

In accordance with another embodiment, the window includes a vehicle window having left and right edges and the multiple parallel elongated strip-shaped electrodes extend horizontally from the left edge to the right edge.

In accordance with another embodiment, the system includes a light source configured to emit light into an edge of the light guide, the support structure includes a vehicle body, the window has inner and outer glass layers, and the light guide is between the inner and outer glass layers.

In accordance with an embodiment, a vehicle is provided that includes a vehicle body; and a vehicle window configured to cover an opening in the vehicle body, the vehicle window has first and second structural window layers attached to each other by polymer and has a light guide layer in the polymer and the light guide layer includes a selective area adjustable haze layer.

In accordance with another embodiment, the adjustable haze layer has multiple individually adjustable areas each of which has a respective transparent electrode and each of which has a haze state that is electrically adjustable.

In accordance with another embodiment, one of the transparent electrodes has an icon shape.

In accordance with another embodiment, the transparent electrodes are arranged in a one-dimensional array across the window.

In accordance with another embodiment, the first and second structural window layers includes respective outer and inner glass layers.

In accordance with another embodiment, the vehicle includes a light source configured to emit light into the light guide layer, the light guide layer includes a light guide core layer, the light guide layer includes cladding for the light guide core layer that is formed at least partly from the polymer, and the selective area adjustable haze layer forms part of the light guide core layer.

In accordance with another embodiment, the light guide core layer includes a polymer layer adjacent to the selective area adjustable haze layer and the selective area adjustable haze layer has electrodes covering different respective areas of the vehicle window.

In accordance with an embodiment, a vehicle window is provided that includes inner and outer glass layers; and a light guide between the inner and outer glass layers include cladding; and a light guide core layer embedded in the cladding that is configured to receive light from a light source, the light guide core layer has a polymer layer and a liquid crystal adjustable haze layer with individually controlled segmented electrodes covering different respective areas.

In accordance with another embodiment, at least part of the cladding includes a polymer material selected from the group consisting of: thermoplastic polyurethane, ethylene-vinyl acetate, and polyvinyl butyral.

The foregoing is merely illustrative and various modifications can be made to the described embodiments. The foregoing embodiments may be implemented individually or in any combination.

What is claimed is:

1. A system, comprising:
a support structure;
a light source that emits light; and
a window in the support structure, the window comprising a light guide that guides the light by total internal reflection across the window and that has a selective area adjustable haze layer.

2. The system defined in claim 1 wherein:
the support structure comprises a vehicle body;
the selective area adjustable haze layer comprises an adjustable layer selected from the group consisting of: a polymer dispersed liquid crystal layer and a polymer network liquid crystal layer;
the window has an outer glass layer and an inner glass layer; and
the light guide comprises a polymer layer adjacent to the selective area adjustable haze layer.

3. The system defined in claim 1 wherein the window comprises an outer glass layer and an inner glass layer.

4. The system defined in claim 3 wherein the light guide comprises a transparent polymer layer and wherein the transparent polymer layer and the selective area adjustable haze layer form a light guide core layer for the light guide.

5. The system defined in claim 4 wherein the light guide comprises cladding.

6. The system defined in claim 5 wherein the cladding comprises a polymer selected from the group consisting of:
thermoplastic polyurethane, ethylene-vinyl acetate, and polyvinyl butyral.

7. The system defined in claim 4 further comprising an electrically adjustable cholesteric liquid crystal layer adjacent to the light guide core layer.

8. The system defined in claim 1 wherein the selective area adjustable haze layer comprises multiple individually adjustable electrodes in different respective areas of the window.

9. The system defined in claim 8 wherein the electrodes comprise multiple parallel elongated strip-shaped electrodes.

10. The system defined in claim 8 wherein the window comprises a vehicle window having left and right edges and wherein the multiple parallel elongated strip-shaped electrodes extend horizontally from the left edge to the right edge.

11. The system defined in claim 1 further comprising a light source configured to emit light into an edge of the light guide, wherein the support structure comprises a vehicle body, wherein the window has inner and outer glass layers, and wherein the light guide is between the inner and outer glass layers.

12. A vehicle, comprising:
a vehicle body; and
a vehicle window configured to cover an opening in the vehicle body, wherein the vehicle window has first and second structural window layers attached to each other by polymer and has a light guide layer in the polymer and wherein the light guide layer comprises a selective area adjustable haze layer.

13. The vehicle defined in claim 12 wherein the adjustable haze layer has multiple individually adjustable areas each of which has a respective transparent electrode and each of which has a haze state that is electrically adjustable.

14. The vehicle defined in claim 13 wherein one of the transparent electrodes has an icon shape.

15. The vehicle defined in claim 13 wherein the transparent electrodes are arranged in a one-dimensional array across the window.

16. The vehicle defined in claim 13 wherein the first and second structural window layers comprises respective outer and inner glass layers.

17. The vehicle defined in claim 13 further comprising a light source configured to emit light into the light guide layer, wherein the light guide layer comprises a light guide core layer, wherein the light guide layer comprises cladding for the light guide core layer that is formed at least partly from the polymer, and wherein the selective area adjustable haze layer forms part of the light guide core layer.

18. The vehicle defined in claim 17 wherein the light guide core layer comprises a polymer layer adjacent to the selective area adjustable haze layer and wherein the selective area adjustable haze layer has electrodes covering different respective areas of the vehicle window.

19. A vehicle window, comprising:
inner and outer glass layers; and
a light guide between the inner and outer glass layers comprising:
cladding; and
a light guide core layer embedded in the cladding that is configured to receive light from a light source, wherein the light guide core layer has a polymer layer and a liquid crystal adjustable haze layer with individually controlled segmented electrodes covering different respective areas.

20. The vehicle window defined in claim 19 wherein at least part of the cladding comprises a polymer material selected from the group consisting of: thermoplastic polyurethane, ethylene-vinyl acetate, and polyvinyl butyral.
